(19) United States
(12) Patent Application Publication
(10) Pub. No.: US 2007/0097924 A1
(43) Pub. Date: May 3, 2007

(54) METHOD AND SYSTEM FOR INTER-TECHNOLOGY ACTIVE HANDOFF OF A HYBRID COMMUNICATION DEVICE

(75) Inventors: Kris K. Martinovich, Streamwood, IL (US); Murali Narasimha, Grayslake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/564,401

(22) Filed: Nov. 29, 2006

Related U.S. Application Data
(63) Continuation-in-part of application No. 11/272,934, filed on Nov. 14, 2005.
(60) Provisional application No. 60/742,584, filed on Dec. 5, 2005.
(60) Provisional application No. 60/629,929, filed on Nov. 22, 2004.

(51) Int. Cl. H04Q 7/00

(52) U.S. Cl. 370/332; 370/331; 455/452.2

(57) ABSTRACT

A communication system provides for reporting a pilot channel of a second network when a mobile station is operating in a first network, wherein the second network implements a different air interface communication technology than the first network. While the mobile station is operating in the first network via radio frequency (RF) resources associated with the first network, the mobile station monitors a pilot channel associated with the second network and determines whether to report the monitored pilot channel based on one or more of an inter-system hard handoff add threshold and an inter-system hard handoff drop threshold. The inter-system hard handoff add and drop thresholds may be pre-programmed into the mobile station or may be provisioned to the mobile station by the first network.

### CROSS REFERENCE TO RELATED APPLICATIONS

The present application is a continuation-in-part of U.S. patent application Ser. No. 11/272,934, attorney docket no. CE13376R, entitled “METHOD AND SYSTEM FOR INTER-TECHNOLOGY ACTIVE HANDOFF OF A HYBRID COMMUNICATION DEVICE,” filed Nov. 22, 2005, and further claims priority from provisional U.S. patent application No. 60/629,929, attorney docket no. CE13376R, entitled “METHOD AND SYSTEM FOR INTER-TECHNOLOGY ACTIVE HANDOFF OF A HYBRID COMMUNICATION DEVICE,” filed Nov. 23, 2004, and provisional patent application No. 60/742,584, attorney docket no. CE15795R, entitled “METHOD AND SYSTEM FOR INTER-TECHNOLOGY ACTIVE HANDOFF OF A HYBRID COMMUNICATION DEVICE,” filed Dec. 5, 2005, which patent applications are commonly owned and incorporated herein by reference in its entirety.

### FIELD OF THE INVENTION

The present invention relates generally to wireless communication systems, and more specifically to handoff of a hybrid communication device between cellular communication networks implementing different air interface technologies.

### BACKGROUND OF THE INVENTION

The evolution of cellular communications has resulted in a proliferation of networks of different technologies and corresponding different air interfaces. As a result, during the course of a single call, a wireless mobile station may roam among multiple networks, wherein each such network implements a different technology than the other networks of the multiple networks. Among the different network technologies are high rate packet data (HRPD) Code Division Multiple Access (CDMA) technologies, such as CDMA 2000 1XEV-DO (1X Evolution Data Optimized) or packet switched CDMA 1XRTT (1X Radio Transmission Technology), that are capable of providing high rate packet data communication services, and legacy CDMA 2000 1X networks.

As the mobile station roams among a legacy CDMA communication network such as a CDMA 2000 1X network and an HRPD CDMA communication network such as a CDMA 2000 1XEV-DO network, it may be beneficial to system performance to handoff the mobile station from the former network to the latter network. For example, the channel conditions associated the latter network may be more favorable than the channel conditions associated with the former network due to such factors as fading, adjacent and co-channel interference, and available power at a serving base station (BS) or radio access network (RAN). By way of another example, an operator of both a legacy CDMA 2000 1X network and an HRPD CDMA 2000 1XEV-DO network may desire to move the mobile station from one such network and to the other such network for purposes of system loading.

Currently, the only defined method for executing a handoff between a legacy CDMA 2000 1X network and an HRPD CDMA 2000 1XEV-DO network is an execution of a dormant hard handoff, wherein a mobile station must go dormant and drop a radio resource of a network of a first CDMA technology and then acquire a radio resource of a network of a second CDMA technology. A result is a brief period of time during which the mobile station is not actively engaged in a communication session with either network. Further, when executing a dormant hard handoff there is no linkage between the two networks as the mobile station must drop the first network and acquire the second network without any assistance from the BS or RAN of either network. As a result, voice/data traffic may be lost during the handoff, resulting in poor system performance and efficiency and disgruntled end users.

Therefore, a need exists for a method and apparatus for implementing an active hard handoff of a communication session between a legacy CDMA 2000 1X network and a HRPD CDMA 2000 1XEV-DO network that minimizes an amount of time that a mobile station is not actively engaged in a communication session with either network during a handoff.

### BRIEF DESCRIPTION OF THE DRAWINGS

FIG. 1 is a block diagram of a wireless communication system in accordance with an embodiment of the present invention.

FIG. 2 is a block diagram of a base station controller in accordance with an embodiment of the present invention.

FIG. 3 is a block diagram of a mobile station in accordance with an embodiment of the present invention.

FIG. 4 is a block diagram of a mobile station in accordance with another embodiment of the present invention.

FIG. 5 is a logic flow diagram of a method executed by the communication system of FIG. 1 in handing off of a communication session from a first network of FIG. 1 to a second network of FIG. 1 in accordance with an embodiment of the present invention.

FIG. 6 is a bit map of an exemplary High Rate Packet Data (HRPD) Information message in accordance with an embodiment of the present invention.

### DETAILED DESCRIPTION OF THE INVENTION

To address the need that exists for a method and apparatus that implements an active hard handoff of a communication session between a first CDMA 2000 network and a high rate packet data CDMA 2000 network, a communication system is provided that provides for reporting a pilot channel of a second network when a mobile station is operating in a first network, wherein the second network implements a different air interface communication technology than the first network. While the mobile station is operating in the first network via radio frequency (RF) resources associated with the first network, the mobile station monitors a pilot channel associated with the second network and determines whether to report the monitored pilot channel based on one or more of an inter-system hard handoff add threshold and an inter-system hard handoff drop threshold. The inter-system hard handoff add and drop thresholds may be pre-programmed into the mobile station or may be provisioned to the mobile station by the first network.

Generally, an embodiment of the present invention encompasses a method for reporting a pilot channel of a second network when a mobile station is operating in a first network, wherein the second network implements a different air interface communication technology than the first network. The method includes conveying forward link bearer traffic to, and receiving reverse link bearer traffic from, the mobile station via radio frequency (RF) resources associated with the first network, while operating in the first network, monitoring a pilot channel associated with the second network, and determining whether to report the monitored pilot channel based on one or more of an inter-system hard handoff add threshold and an inter-system hard handoff drop threshold.

Another embodiment of the present invention encompasses a method for facilitating a reporting of a pilot channel of a second network associated with a different air interface communication technology when a mobile station is operating in a first network, wherein the second network implements a different air interface communication technology than the first network. The method includes conveying, by the first network, the inter-system hard handoff add threshold and the inter-system hard handoff drop threshold and receiving, by the first network from the mobile station, a pilot channel quality associated with the pilot channel of the second network.

Still another embodiment of the present invention encompasses a mobile station capable of operating in each network of a plurality of networks, wherein each network of the plurality of networks is associated with a different air interface communication technology than the other networks of the plurality of networks. The mobile station includes an at least one memory device that maintains one or more of an inter-system hard handoff add threshold and an inter-system hard handoff drop threshold and a processor coupled to the at least one memory device that is configured to, when operating in a first network of the plurality of networks, convey forward link bearer traffic and receive reverse link bearer traffic via radio frequency (RF) resources associated with the first network, monitoring a pilot channel associated with a second network of the plurality of networks, and determine whether to report the monitored pilot channel based on one or more of the inter-system hard handoff add threshold and the inter-system hard handoff drop threshold.

Yet another embodiment of the present invention encompasses a base station controller of a first network that facilitates a reporting of a pilot channel associated with a second network, wherein the second network implements a different air interface communication technology than the first network, wherein the base station controller comprises a processor that is configured to convey an inter-system hard handoff add threshold and the inter-system hard handoff drop threshold and to receive a pilot channel quality associated with the pilot channel of the second network.

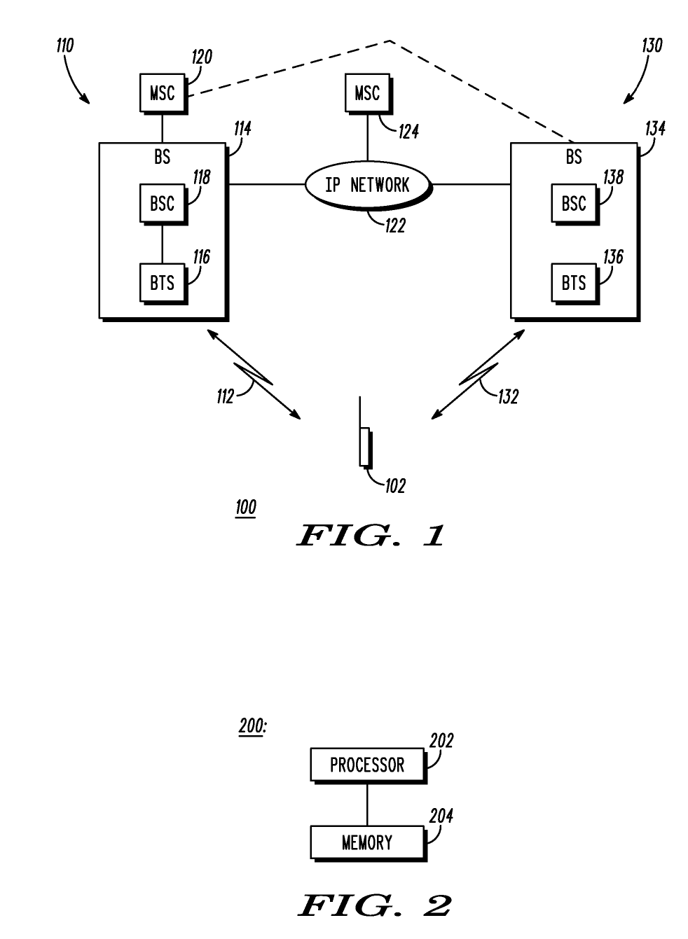

Turning now to the drawings, the present invention may be more fully described with reference to FIGS. 1-6. FIG. 1 is a block diagram of a wireless communication system 100 in accordance with an embodiment of the present invention. Communication system 100 includes a first network 110 such that implements a first air interface technology and a second, network 130 that implements an second, different air interface technology. Each of network 110 and network 130 includes a respective Base Station 114, 134 that comprises a respective Base Transceiver Station (BTS) 116, 136 coupled to a respective Base Station Controller (BSC) 118, 138. Network 110 further includes a Mobile Switching Center (MSC) 120 that is coupled to BS 114, and in particular to BSC 118. MSC 120 may be further coupled to BS 134, and in particular to BSC 138. Networks 110 and 130, and more particularly BSs 114 and 134, are each further coupled to a Packet Data Serving Node (PDSN) 124 and via the PDSN to an external network (not shown) for an exchange of communications with distant parties external to communication system 100.

MSC 120 is coupled to a Home Location Register (HLR) (not shown) and a Visited Location Register (VLR) (not shown). As is known in the art, the HLR and VLR includes mobility and provisioning information associated with each mobile station subscribed to and/or registered for the services of the MSC's associated network 110, such as a profile of the mobile station, including the capabilities of the mobile station, and a BS currently serving the mobile station. BSs 114 and 134 each provides wireless communication services to the mobile stations located in a coverage area of the BS via a respective air interface 112, 132. Each air interface 112, 132 includes a forward link that includes multiple forward link traffic channels and multiple forward link signaling channels, such as common and dedicated signaling channels. Each air interface 112, 132 further includes a reverse link that includes multiple reverse link traffic channels, multiple reverse link signaling channels, such as common and dedicated signaling channels, and an access channel. Each of the forward link and reverse link of air interface 132 further comprises a channel that is dedicated to first network-type messaging, that is, to an exchange of 3G1X (Third generation 1X) messages when the first network is a CDMA 2000 1X system, in the second network, such as a CDMA 2000 1XEV-DO network. For ease of reference, this channel is referred to herein as a 3G1X channel.

Each of network 110 and network 130, and more particularly BSs 114 and 134, communicate with each other, and with Packet Data Serving Node (PDSN) 124, via an Internet Protocol (IP)-based network 122. In various embodiments of the present invention, BSs 114 and 134 may communicate via a proprietary interface, a new ‘A’ interface, or via a well-known intersystem protocol, such as the protocol described in the 3GPP2 (Third Generation Partnership Project 2) TIA-41 (Telecommunications Industry Association-41) standard, that is, 3GPP2 N.S0005. The TIA-41 standard provides standardized intersystem procedures for mobility management in cellular systems and prescribes messaging among Mobile Switching Centers, Home Location Registers (HLRs), Visited Location Registers (VLRs), Authentication, Authorization, and Accounting functionality (AAAs), and other core network elements of cellular systems in order to provide services to mobile stations when interaction is required between different cellular systems. In another embodiment of the present invention, BSs 114 and 134 may communicate via an extension of an A1 interface by providing a connection between the BSs via MSC 120.

Communication system 100 further includes a wireless mobile station (MS) 102, for example but not limited to a cellular telephone, a radiotelephone, or a Personal Digital Assistant (PDA), personal computer (PC), or laptop computer equipped for wireless voice communications. In various communications systems, mobile station 102 may also be referred to as an access terminal (AT). Mobile station 102 comprises a hybrid terminal that is capable of engaging in a voice or data call with both first network 110 and second network 130. For example, in one embodiment of the present invention, mobile station 102 may include a separate transceiver for operation in each of first network 110 and second network 130, thereby allowing the mobile station to concurrently transmit or receive in each of the two networks.

FIG. 2 is a block diagram of a BSC 200, such as BSCs 118 and 138, in accordance with an embodiment of the present invention. BSC 200 includes a processor 202, such as one or more microprocessors, microcontrollers, digital signal processors (DSPs), combinations thereof or such other devices known to those having ordinary skill in the art. The particular operations/functions of processor 202, and thus of BSC 200, is determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor.

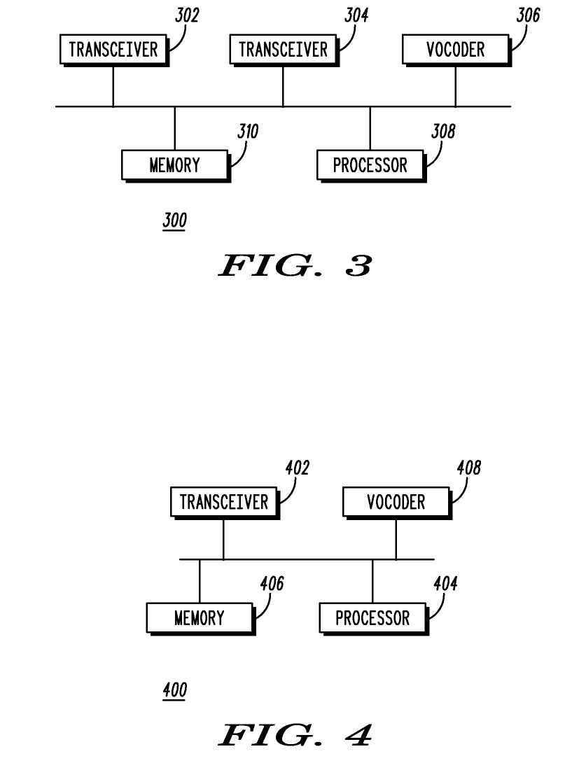

Referring now to FIG. 3, in one embodiment of the present invention, a hybrid MS 300, such as MS 102, capable of operating in communication system 100 may include multiple transceivers, that is, a first transceiver 302 for operation in first network 110 and a second transceiver 304 for operation in second network 130, thereby allowing the MS to concurrently transmit or receive in each of the two networks. Each transceiver is coupled to a vocoder 306 and a processor 308, which processor is further coupled to an at least one memory device 310.

In another embodiment of the present invention, and referring now to FIG. 4, a hybrid MS 400, such as MS 102, capable of operating in communication system 100 may include a single transceiver 402 that emulates the operation of dual transceivers, such as transceivers 302 and 304. Transceiver 402 is coupled to a processor 404, which processor is further coupled to an at least one memory device 406. Processor 404 may cause transceiver 402 to rapidly switch between networks 110 and 130 to give the appearance of concurrent operation. Further, MS 400 may maintain apriori information in at least one memory device 406 that facilitates the switching between networks at optimum times.

Each of processors 308 and 404 may comprise one or more microprocessors, microcontrollers, digital signal processors (DSPs), combinations thereof or such other devices known to those having ordinary skill in the art, which processor is configured to execute the functions described herein as being executed by mobile station 102. Each of at least one memory devices 310 and 406 may comprise random access memory (RAM), dynamic random access memory (DRAM), and/or read only memory (ROM) or equivalents thereof, that store data and programs that may be executed by the associated processor and that allow mobile station 102 to perform all functions necessary to operate in communication system 100.

The embodiments of the present invention preferably are implemented within BSC 118 and MS 102, and more particularly with or in software programs and instructions stored in the respective at least one memory device 204, 310, 406 and respectively executed by processors 202, 308, 404 of the BSC and MS. However, one of ordinary skill in the art realizes that the embodiments of the present invention alternatively may be implemented in hardware, for example, integrated circuits (ICs), application specific integrated circuits (ASICs), and the like, such as ASICs implemented in one or more of BSC 118 and MS 102. Based on the present disclosure, one skilled in the art will be readily capable of producing and implementing such software and/or hardware without undo experimentation.

In order for MS 102 to engage in a voice call with a distant party via one or more of network 110 and network 130, each of MS 102 and networks 110 and 130 operates in accordance with well-known wireless telecommunications protocols. Preferably, first network 110 is a CDMA 2000 1X system that operates in accordance with the CDMA 2000 1X standards. Further, second network 130 preferably is a CDMA 2000 1XEV-DO (1X Evolution Data Optimized) system that operates in accordance with the 3GPP2 and TIA/EIA (Telecommunications Industry Association/Electronic Industries Association) IS-856 and 3GPP2 C.S0024 standards, which provide compatibility standards for CDMA 2000 1XEV-DO systems. While each of network 110 and network 130 may implement a high rate packet data (HRPD) communication technology, references herein to an HRPD BS, pilot channel, pilot channel measurement, pilot channel threshold, and so on may be deemed to refer to a BS, pilot channel, pilot channel measurement, pilot channel threshold, etc. associated with network 130.

Further, each of air interfaces 112 and 132, and correspondingly each of network 110, network 130, and mobile station 102, preferably operates in accordance with the TIA/EIA (Telecommunications Industry Association/Electronic Industries Association) IS-2001 (3GPP2 A.S0011 to A.S0017 Inter Operability Specification, or IOS) standards, which provide a compatibility standard for cellular mobile telecommunications systems that operate as a CDMA 2000 system, such as 1X, 1XEV-DO, 1XEV-DV, and 1XRTT, or any other technology supported by a TIA-2001 based Access Network. In addition, MS 102, air interface 132, and BS 134 preferably further operates in accordance with the 3GPP2 A.S0008-0 v3.0 and 3GPP2 A.S0007-A v1.0 Inter Operability Specifications (IOS) for a High Rate Packet Data (HRPD) access network. To ensure compatibility, radio system parameters and call processing procedures are specified by the standards, including call processing steps that are executed by an MS and a base station serving the MS and between the BS and associated infrastructure in order to establish a call or execute a handoff.

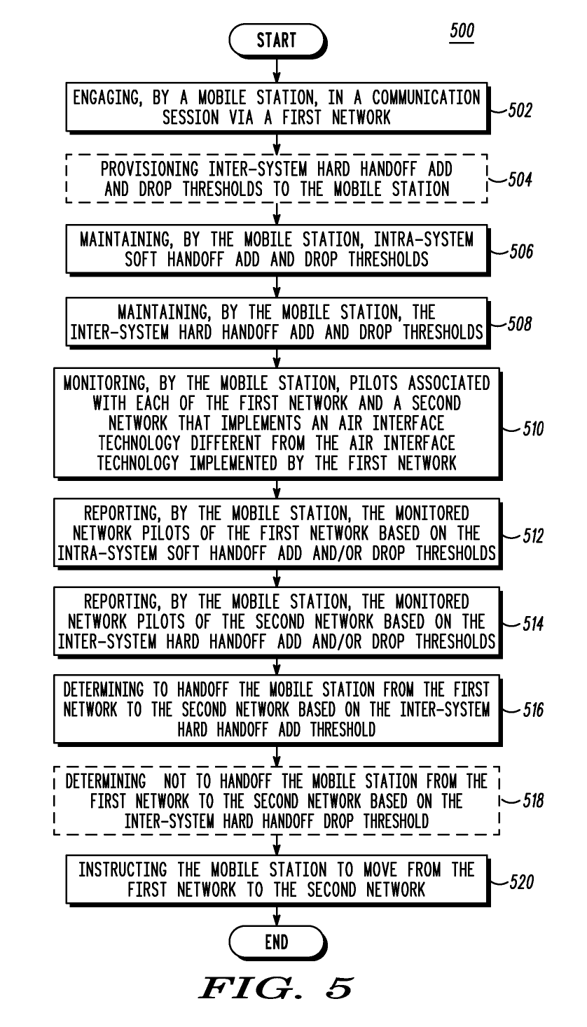

In communication system 100, MS 102 may roam through the system when the MS is engaged in a voice or data communication session. As a result of the roaming, situations may arise where it is desirable to hand off MS 102 from first network 110 to second network 130. In order to facilitate a handoff of MS 102, communication system 100 provides a method and apparatus for an active handoff of the MS from first network 110 to second network 130 when the MS is actively engaged in a communication session. Referring now to FIG. 5, a logic flow diagram 500 is provided that depicts a handoff executed by communication system 100 in handing off a communication session from first network 110 to second network 130 in accordance with an embodiment of the present invention.

Logic flow diagram 500 begins when MS 102 is actively engaged (502) in a communication session with a distant party via a current network in use, that is, first network 110. In order to participate in the communication session via first network 110, MS 102 must already be registered with the first network. Registration procedures are well-known in the art and will not be described in detail herein except to note that when an MS registers with a network, the network stores in an associated HLR or VLR, or an associated Foreign Agent (FA) or Home Agent (HA), whichever is appropriate, an identification of a BS associated with the network and serving the MS.

MS 102 maintains (506), in an at least one memory device of the MS, such as at least one memory device 310 or 406, first (1X) intra-system soft handoff add and drop thresholds that are associated with first network 110, which intra-system add and drop thresholds are utilized by the MS to add a BS and/or BTS to, and to drop a BS and/or BTS from, an active set of the MS. MS 102 further maintains (508), in the an at least one memory device of the MS, inter-system hard handoff add and drop thresholds associated with second network 130, which inter-system add and drop thresholds are utilized by the MS to determine whether to request an inter-system handoff from first network 110 to second network 130. When a quality of a pilot channel (hereinafter referred to as a “pilot”) of second network 130, and more particularly of air interface 132, is measured by MS 102 while the MS is operating in first network 110, and when the measured quality compares favorably to the inter-system hard handoff add threshold (exceeds the threshold in the event of a signal strength measurement), the MS reports the pilot back to BS 114, and more particularly BSC 118. When a previously reported pilot of second network 130, and more particularly of air interface 132, is measured by MS 102 when operating in first network 110 and compares unfavorably with the inter-system hard handoff drop threshold (falls below the inter-system hard handoff drop threshold in the event of a signal strength measurement), the MS reports the pilot back to BS 114, and more particularly BSC 118.

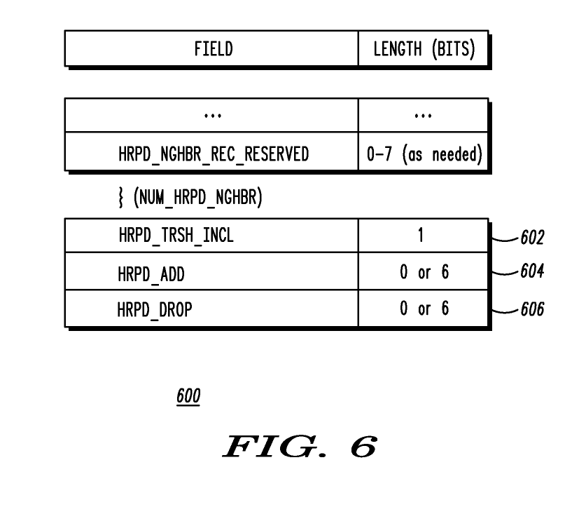

In one embodiment of the present invention, an operator of communication system 100 may program into MS 102 the inter-system hard handoff add and drop thresholds associated with second network 130. In another embodiment of the present invention, BS 114, and more particularly BSC 118 of the BS, may provision (504) the inter-system hard handoff add and drop thresholds to MS 102 via an overhead message, which inter-system hard handoff add and drop thresholds may be maintained by the BS in an at least one memory device 204 of BSC 118. In one such embodiment, the overhead message may comprise an HRPD Information message instructing MS 102 to report HRPD signal strengths. Referring now to FIG. 6, a bit map is provided of an exemplary HRPD Information Message 600 in accordance with an embodiment of the present invention. HRPD Information Message 600 includes a HRPD_ADD data field 604 that informs of an inter-system hard handoff add threshold and a HRPD_DROP data field 606 that informs of an inter-system hard handoff drop threshold. Preferably, HRPD Information Message 600 further includes a message type data field identifying the message as an HRPD Information message (for example, MSG_TAG: HRPDIM) and an HRPD_TRSH_INCL data field 602 that informs whether HRPD pilot strength thresholds are included in the message.

BS 114 may set a value of HRPD_TRSH_INCL data field to ‘1’ if HRPD capable MSs, such as MS 102, are required to report HRPD pilot strength measurements in accordance with the HRPD_ADD and HRPD_DROP threshold values; otherwise, this field may be set to ‘0’. HRPD_ADD corresponds to an HRPD pilot detection threshold. When HRPD_TRSH_INCL is set to ‘1,’ BS 114 may include HRPD_ADD data field 604 in HRPD Information message 600 and include a value in the field corresponding to a signal strength value sufficient to facilitate a hard handoff from first network 110 to second network 130; otherwise, data field 604 may be omitted. BS 114 may set HRPD_ADD data field 604 to a pilot detection threshold, expressed as an unsigned binary number equal to ‘−2×10×log₁₀ E_{c}/I₀.’ HRPD_DROP data field 606 corresponds to an HRPD pilot drop threshold. When HRPD_TRSH_INCL 602 is set to ‘1’, BS 114 may include the HRPD_DROP data field 606 in HRPD Information message 600 and include a value in the field corresponding to a signal strength value that triggers an MS, such as MS 102, to report a drop in signal strength of previously reported HRPD pilots; otherwise, data field 606 may be omitted. BS 114 may set HRPD_DROP data field 606 to a pilot drop threshold, expressed as an unsigned binary number equal to └−2×10×log₁₀ E_{c}/I₀┘.

As part of the communication session, mobile station 102 conveys 202 reverse link frames comprising bearer traffic to PDSN 124 via a reverse link traffic channel of air interface 112, BS 114, and IP network 122 for routing to the distant party via an external network (not shown). Further, when PDSN 124 receives bearer traffic from the distant party and intended for mobile station 102, the PDSN routes 203 the voice information to BS 114 via IP network 122 and the BS conveys forward link frames comprising the bearer traffic to mobile station 102 via a forward link traffic channel of air interface 112.

While MS 102 is engaged in the communication session with BS 114, the MS monitors (510) qualities, in particular a signal strength or alternatively any of a variety of other signal qualities such as a signal-to-noise ratio (SNR), a carrier-to-interference ratio (C/I), pilot power-to-total power (Ec/Io) ratio, a bit error rate (BER), or a frame error rate (FER), of pilots associated with each of BS 114 of network 110 and BS 134 of network 130. MS 102 may monitor the pilots of each network 110, 130 concurrently or may switch between networks in monitoring the pilots. MS 102 may self-determine when or whether to monitor the pilots associated with BS 134 of second network 130 or may monitor the pilots in response to receiving an instruction to do so from first network 110, and in particular one of BSC 118 and MSC 120.

MS 102 reports (512) the monitored pilot(s) of first BS 114 and air interface 112 in accordance with well known reporting procedures. For example, when a monitored pilot exceeds a 1X intra-system soft handoff add threshold, the MS reports this pilot, and the measured pilot channel strength, to BS 114, and in particular to BSC 118, in a Pilot Strength Measurement Message (PSMM) conveyed to the BS via the reverse link of air interface 112. Similarly, when a monitored pilot falls below a 1X intra-system soft handoff drop threshold, the MS reports this pilot, and the measured pilot signal strength, to BS 114, and in particular to BSC 118, in a PSMM conveyed to the BS via the reverse link of air interface 112. BSC 118 then stores the reported first network pilot measurements in the at least one memory device 204 of the BSC. In the prior art, a report of a pilot that exceeds a 1X intra-system soft handoff add threshold is an indicator to add a first BS/BTS associated with that pilot to soft handoff with the MS and a report of a pilot that falls below a 1X intra-system soft handoff drop threshold is an indicator to drop a BS/BTS associated with that pilot from soft handoff with the MS.

When a quality of a pilot of second network 130, and more particularly of air interface 132, is measured by MS 102 when operating in first network 110 and exceeds the inter-system hard handoff add threshold, or a quality of a previously reported pilot of second network 130, and more particularly of air interface 132, is measured by MS 102 when operating in first network 110 and falls below the inter-system hard handoff drop threshold, the MS reports (514) the monitored HRPD pilot(s) back to first BS 114, and more particularly BSC 118. BSC 118 then stores the reported HRPD pilot measurements in the at least one memory device 204 of the BSC.

MS 102 may report HRPD pilot strengths by sending a modified version of a first network 110 message delivery mechanism, such as a Data Burst Message (DBM), to BS 114 on a reverse link dedicated signaling channel (r-dsch) of air interface 112. In response to receiving the DBM, first BS 114 parses the message and recognizes the message as comprising an HRPD pilot signal strength measurement. The DBM includes a BURST_TYPE data field that is set to ‘001001’ or another identifier that identifies the message as reporting HRPD pilot signal strengths. Various data field of the DBM may be set as follows: a MSG_NUMBER data field may be set to ‘00000001,’ a NUM_MSGS data field may be set to ‘00000001,’ a NUM_FIELDS data field may be set to a number of octets in the HRPD Pilot Strength Report Record, and CHARi data fields may be set to the corresponding octets of the HRPD Pilot Strength Report Record as in the following table:

HRPD Pilot Strength Report Record

| Data Field | Length (bits) |
|---|---|
| REF_PN | 9 |
| PILOT_STRENGTH | 6 |
| NUM_HRPD_PILOTS | 4 |
| NUM_HRPD_PILOTS occurrences of the following record: | |
| {NUM_HRPD_PILOTS | |
| HRPD_PILOT_PN_PHASE | 15 |
| HRPD_PILOT_STRENGTH | 6 |
| }NUM_HRPD_PILOTS | |
| RESERVED | 0-7 (as needed) |

REF_PN corresponds to a time reference pseudorandom number (PN) sequence offset associated with first network 110. MS 102 may set this field to the PN sequence offset of the CDMA 2000 1X pilot used by the MS to derive its time reference, relative to the zero offset pilot PN sequence, in units of 64 PN chips. PILOT_STRENGTH corresponds to a measured strength of a pilot of first network 110, in dB. MS 102 may set this field to
└−2×10 log₁₀ PS┘,
where ‘PS’ is the strength of a first pilot, such as a CDMA 2000 1X pilot, used by MS 102 to derive its time reference. If this value (−2×10 log₁₀ PS) is less than 0, then MS 102 may set this field to ‘000000’. If this value is greater than ‘111111’, then MS 102 may set this field to ‘111111’. NUM_HRPD_PILOTS corresponds to a number of HRPD pilots reported by MS 102. MS 102 may set this field to the number of HRPD pilots being reported.

For each HRPD handoff candidate, MS 102 may include in the DBM a two field record for each measured occurrence of a pilot associated with that candidate, that is, a first, HRPD_PILOT_PN_PHASE data field and a second, HRPD_PILOT_STRENGTH data field. HRPD_PILOT_PN_PHASE corresponds to a phase of the pilot measured by MS 102. MS 102 may set this field to the phase of the HRPD pilot PN sequence relative to the zero offset pilot PN sequence of the pilot, in units of one PN chip. HRPD_PILOT_STRENGTH corresponds to a pilot strength of the measured pilot, in dB. MS 102 may set HRPD_PILOT_STRENGTH to
└−2×10 log₁₀ PS┘,
where ‘PS’ is the strength of the HRPD pilot. If this value (−2×10 log₁₀ PS) is less than 0, MS 102 may set this field to ‘000000’. If this value is greater than ‘111111’, MS 102 may set this field to ‘111111’.

MS 102 report HRPD pilot strengths in accordance with the HRPD_ADD and HRPD_DROP threshold settings if these fields are included in the HRPD Information Message. When a measured pilot(s) first exceeds the HRPD_ADD threshold, MS 102 may report the pilot strength(s) by sending the above described DBM, with BURST_TYPE data field set to ‘001001’. Similarly when the strength of these same pilot(s) fall below the HRPD_DROP threshold, MS 102 may report this to BS 114 via the DBM, again with BURST_TYPE data field set to ‘001001’.

In another embodiment of the present invention, instead of sending the measured HRPD pilot strengths to BS 114 via a DBM, MS 102 may convey the measured HRPD pilot strengths in a modified version of a CDMA1X Pilot Strength Measurement Message (PSMM), which message is modified to include data fields informing of the measured HRPD pilot strengths. Use of a modified version of a CDMA1X PSMM would minimize extra messaging required by a DBM.

Based on the first pilot measurements associated with BS 114 and the HRPD pilot measurements associated with BS 134 and reported by MS 102, first network 110, and in particular BS 114 or MSC 120 may then determine (516) to handoff MS 102 to second network 130 and BS 134. For example, when a pilot of BS 114 compares unfavorably to (is below, in the case of a signal strength threshold) the 1X intra-system soft handoff drop threshold and/or a pilot of BS 134 compares favorably to (exceeds, in the case of a signal strength threshold) the HRPD inter-system hard handoff add threshold, this may indicate a desirability of a handoff. By way of another example, costs associated with operating MS 102 on network 110 may be different from the costs associated with operating MS 102 on network 130. In turn, an operator (or operators) of networks 110 and 130 may charge a different fee for use of each network. If second network 130 is the lower cost network, a user of MS 102 may program into the MS a directive to operate on the second network 130 whenever a measurement of a pilot associated with the second network compares favorably to the HRPD inter-system hard handoff add threshold. By way of still another example, for load leveling purposes, for network cost consideration purposes, or due to a need to clear traffic channels in a coverage area in order to facilitate emergency communications, an operator of a communication system such as communication system 100 may find it desirable to move an MS, such as mobile station 102, that is actively engaged in a voice call in first network 110 to second network 130 whenever a measurement of a pilot associated with the second network compares favorably to the HRPD inter-system hard handoff add threshold.

On the other hand, the processing of an inter-system hard handoff may be time consuming or, even when desirable, may nevertheless get deferred. As a result, communication system 100 provides for a continuing monitoring of the pilot(s) associated with second network 130 (that is, BS 134) and when a pilot that compared favorably to the inter-system hard handoff add threshold later, in a subsequent monitoring of the pilot and prior to consummation of the handoff, compares unfavorably to the inter-system hard handoff drop threshold, the handoff may be terminated (518) by MS 102 or BS 114, in particular BSC 118, or the pilot may be dropped by the MS, BS, and/or BSC as a potential handoff target.

In response to determining to handoff MS 102 from first network 110 and BS 114 to second network 130 and BS 134, first network 110 instructs (520) MS 102 to move to second network 130 and BS 134. MS 102 may then be handed off from first network 110 and BS 114 to second network 130 and BS 134 in accordance with one of the various inter-technology handoff techniques described in detail in U.S. patent application Ser. No. 11/272,934, entitled “METHOD AND SYSTEM FOR INTER-TECHNOLOGY ACTIVE HANDOFF OF A HYBRID COMMUNICATION DEVICE,” filed Nov. 22, 2005, and U.S. patent application Ser. No. 11/282,918, entitled “METHOD AND APPARATUS FOR INTER-SYSTEM ACTIVE HANDOFF OF A HYBRID MOBILE STATION,” filed Nov. 22, 2005, which patent applications are commonly owned and incorporated herein by reference in its entirety. Logic flow 500 then ends.

In one embodiment of the invention, first network 110 may instruct MS 102 to move to second network BS 134 without assigning a traffic channel to the MS. For example, BS 114 may convey to MS 102, and the MS may receive from the BS, a Data Burst Message (DBM) on a forward link dedicated signaling channel (f-dsch) of air interface 112 instructing the MS to monitor a pilot associated with second network 130, and more particularly with BS 134. The DBM may then comprise a ‘BURST_TYPE’ data field set to ‘001000’ and a ‘TCH_ASSIGN_INCL’ data field set to ‘0.’ In response to receiving the DBM, MS 102 may set HRPD_HO_TARGET_BANDₛ to HRPD_HO_TARGET_BANDᵣ, set HRPD_HO_TARGET_FREQₛ to HRPD_HO_TARGET_FREQᵣ, and set HRPD_HO_TARGET_PNₛ to HRPD_HO_TARGET_PNᵣ, wherein ‘s’ represents ‘stored’ values and ‘r’ represents ‘received’ values and wherein the ‘received’ values are copied to the ‘stored’ variable. MS 102 may the proceed to open a connection on target second network 130 in accordance with the system information received in the BDM message.

In another embodiment of the invention, first network 110 may instruct MS 102 to move to second network BS 134 while assigning a traffic channel to the MS. For example, BS 114 may convey to MS 102, and the MS may receive from the BS, a DBM on an f-dsch of air interface 112 instructing the MS to monitor a pilot associated with second network 130, and more particularly with BS 134, which DBM comprises a ‘BURST_TYPE’ field set to ‘001000’ and a ‘TCH_ASSIGN_INCL’ data field set to ‘1.’ In response to receiving such a DBM, MS 102 may then set HRPD_HO_TARGET_BANDₛ to HRPD_HO_TARGET_BANDᵣ, set traffic channel assignment internal variables received in a TCH_ASSIGN_BLOB, as is known in the art, in accordance with the Connection Layer TrafficChannelAssignment message format, and proceed to acquire the target HRPD traffic channel specified in the DBM in accordance with known Traffic Channel Assignment message processing procedures.

Further, when BS 114 directs MS 102 to handoff to second network 130, the BS sends a DBM on a forward link dedicated signaling channel (f-dsch) of air interface 112 with the BURST_TYPE field set to 001000. BS 114 may include an HRPD Handoff Record in the DBM wherein the BS may set a MSG_NUMBER value to ‘00000001,’ may set a NUM_MSGS value to ‘00000001,’ may set a ‘NUM_FIELDS’ value to a number of octets in the HRPD Handoff Record, and may set CHARi data fields to corresponding octets of the HRPD Handoff Record as noted in the following table:

HRPD Handoff Record

| Field | Length (bits) |
|---|---|
| HRPD_HO_TARGET_BAND | 5 |
| TCH_ASSIGN_INCL | 1 |
| HRPD_HO_TARGET_FREQ | 0 or 11 |
| HRPD_HO_TARGET_PN | 0 or 9 |
| TCH_ASSIGN_BLOB | Refer to [1] |
| RESERVED | 0-7 (as needed) |

The HRPD_HO_TARGET_BAND data field corresponds to a band class of the target second network 130. BS 114 may set this field to the band class of the target second network that the MS is expected to acquire. The TCH_ASSIGN_INCL data field informs whether a traffic channel assignment is included in the DBM. BS 114 may set this field to ‘1’ when including an HRPD traffic channel assignment in the message and may otherwise set this field is set to ‘0’. The HRPD_HO_TARGET_FREQ data field corresponds to a frequency of target second network 130. When TCH_ASSIGN_INCL is set to ‘0’, BS 114 may include this field and set it to the frequency of target second network 103 that MS 102 is expected to acquire; otherwise, this field may be omitted. The HRPD_HO_TARGET_PN data field corresponds to a pseudorandom number (PN) offset of the target second network. When TCH_ASSIGN_INCL is set to ‘0’, BS 114 may set this field to the PN sequence offset of second network 130 that the MS is expected to acquire; otherwise, this field may be omitted. The TCH_ASSIGN_BLOB data field provides traffic channel information when a traffic channel assignment is included in the DBM. When TCH_ASSIGN_INCL is set to ‘1’, BS 114 may include HPRD traffic channel assignment information here, which includes data fields that may conform to the Connection Layer message format defined for a TrafficChannelAssignment message; otherwise, this field is not included.

While the present invention has been particularly shown and described with reference to particular embodiments thereof, it will be understood by those skilled in the art that various changes may be made and equivalents substituted for elements thereof without departing from the scope of the invention as set forth in the claims below. Furthermore, one of ordinary skill in the art realizes that the components and operations of the transmitting communication device and receiving communication device detailed herein are not intended to be exhaustive but are merely provided to enhance an understanding and appreciation for the inventive principles and advantages of the present invention, rather than to limit in any manner the invention. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for reporting a pilot channel of a second network when a mobile station is operating in a first network, wherein the second network implements a different air interface communication technology than the first network wherein the method comprises:
conveying forward link bearer traffic to, and receiving reverse link bearer traffic from, the mobile station via radio frequency (RF) resources associated with the first network;
while operating in the first network, monitoring a pilot channel associated with the second network; and
determining whether to report the monitored pilot channel based on one or more of an inter-system hard handoff add threshold and an inter-system hard handoff drop threshold.

2. The method of claim 1, wherein determining whether report the monitored pilot channel comprises determining to report a monitored pilot channel when a quality of the monitored pilot channel exceeds the inter-system hard handoff add threshold.

3. The method of claim 2, wherein determining whether report the monitored pilot channel further comprises determining to report a previously reported pilot channel when a quality of the previously reported pilot channel falls below the inter-system hard handoff drop threshold.

4. The method of claim 1, further comprising reporting the monitored pilot channel of the second network to the first network via an air interface of the first network.

5. The method of claim 4, wherein reporting comprises conveying a quality associated with the monitored pilot channel of the second network to the first network via a Data Burst Message.

6. The method of claim 4, wherein reporting comprises conveying a quality associated with the pilot channel of the second network to the first network via a Pilot Signal Measurement Report.

7. The method of claim 1, further comprising receiving the inter-system hard handoff add threshold and the inter-system hard handoff drop threshold from the first network.

8. The method of claim 7, wherein receiving the inter-system hard handoff add threshold and the inter-system hard handoff drop threshold from the first network comprises receiving the inter-system hard handoff add threshold and the inter-system hard handoff drop threshold from the first network via an overhead message.

9. A method for facilitating a reporting of a pilot channel of a second network associated with a different air interface communication technology when a mobile station is operating in a first network, wherein the second network implements a different air interface communication technology than the first network, the method comprising:
conveying, by the first network, the inter-system hard handoff add threshold and the inter-system hard handoff drop threshold; and
receiving, by the first network from the mobile station, a pilot channel quality associated with the pilot channel of the second network.

10. The method of claim 9, further comprising storing, by the first network, the received pilot channel quality.

11. The method of claim 9, further comprising determining to handoff the mobile station to the second network based on the received pilot channel quality.

12. A mobile station capable of operating in each network of a plurality of networks, wherein each network of the plurality of networks is associated with a different air interface communication technology than the other networks of the plurality of networks, wherein the mobile station comprises:
at least one memory device that maintains one or more of an inter-system hard handoff add threshold and an inter-system hard handoff drop threshold; and
a processor coupled to the at least one memory device that is configured to, when operating in a first network of the plurality of networks, convey forward link bearer traffic and receive reverse link bearer traffic via radio frequency (RF) resources associated with the first network, monitoring a pilot channel associated with a second network of the plurality of networks, and determine whether to report the monitored pilot channel based on one or more of the inter-system hard handoff add threshold and the inter-system hard handoff drop threshold.

13. The mobile station of claim 12, wherein the processor is further configured to determine whether to report the monitored pilot channel by determining to report a monitored pilot channel when a quality of the monitored pilot channel exceeds the inter-system hard handoff add threshold.

14. The mobile station of claim 13, wherein the processor is further configured to determine whether to report the monitored pilot channel by determining to report a previously reported pilot channel when a quality of the previously reported pilot channel falls below the inter-system hard handoff drop threshold.

15. The mobile station of claim 12, wherein the mobile station reports the monitored pilot channel associated with the second network to the first network.

16. The mobile station of claim 15, wherein the processor is further configured to report a quality associated with the pilot channel associated with the second network to the first network via a Data Burst Message.

17. The mobile station of claim 15, wherein the processor is further configured to report a quality associated with the monitored pilot channel associated with the second network to the first network via a Pilot Signal Measurement Report.

18. The mobile station of claim 12, wherein the mobile station receives the inter-system hard handoff add threshold and the inter-system hard handoff drop threshold from the first network.

19. The mobile station of claim 18, wherein the mobile station receives the inter-system hard handoff add threshold and the inter-system hard handoff drop threshold from the first network via an overhead message.

20. A base station controller of a first network that facilitates a reporting of a pilot channel associated with a second network, wherein the second network implements a different air interface communication technology than the first network, wherein the base station controller comprises a processor that is configured to convey an inter-system hard handoff add threshold and the inter-system hard handoff drop threshold and to receive a pilot channel quality associated with the pilot channel of the second network.

21. The base station controller of claim 20, wherein the base station controller further comprises an at least one memory device coupled to the processor and wherein the processor stores the received pilot channel quality in the at least one memory device.

22. The base station controller of claim 20, wherein the processor is further to determine to handoff the mobile station to the second network based on the received pilot channel quality.
